(19) United States
(12) Patent Application Publication
(10) Pub. No.: US 2015/0026683 A1
(43) Pub. Date: Jan. 22, 2015

(54) DATA CONTROL SYSTEM FOR VIRTUAL ENVIRONMENT

(71) Applicant: Quantum Corporation, San Jose, CA (US)

(72) Inventors: Gregory L. Wade, San Jose, CA (US); J. Mitchell Haile, Somerville, MA (US)

(21) Appl. No.: 14/509,749

(22) Filed: Oct. 8, 2014

Related U.S. Application Data
(63) Continuation of application No. 13/459,451, filed on Apr. 30, 2012.
(60) Provisional application No. 61/480,572, filed on Apr. 29, 2011.

(51) Int. Cl. G06F 9/455; G06F 17/30

(52) U.S. Cl. CPC G06F 9/45533; G06F 17/30203
USPC 718/1

(57) ABSTRACT

Embodiments disclosed herein provide systems, methods, and computer readable media for file system access to a virtual machine environment. In a particular embodiment, a data control system comprising a processing system is provided. The processing system is configured to provide a file system interface to a virtual machine environment and receive a file system request for the first file system represented in a first format. The processing system is further configured to convert the file system request into an application program interface (API) for the virtual machine environment.

### RELATED APPLICATIONS

This application is a continuation of U.S. patent application Ser. No. 13/459,451, entitled “DATA CONTROL SYSTEM FOR VIRTUAL ENVIRONMENT,” filed on Apr. 30, 2012; which is related to and claims priority to U.S. Provisional Application No. 61/480,562, filed Apr. 29, 2011, which are hereby incorporated by reference in their entirety.

### TECHNICAL BACKGROUND

Virtual machines operate using software programs known as hypervisors that manage the virtual machine environments. Storage volumes, sometimes referred to as virtual disk files, are maintained by the hypervisors to simulate physical hardware elements, including storage media and any data stored thereon. Different types of hypervisors use different, and sometimes proprietary, formats for their virtual disk files. Consequently, accessing data within the virtual disk files and managing the virtual disk files themselves is restricted to software that is designed to access the virtual disk files of a particular hypervisor.

Unfortunately, using specifically designed software to access the underlying contents of a hypervisors storage volumes can be very resource intensive. This causes a reduction in the performance of a virtual machine and other operations within a virtual machine environment.

Furthermore, the need for specifically designed software to manage virtual disk files prevents software applications that manage data in a file system to perform the same functions with respect to the virtual disk files as they would other files in the file system. Thus, without modification, those data management software applications would not be able to operate on the virtual disk files.

### OVERVIEW

Embodiments disclosed herein provide systems, methods, and computer readable media for file system access to a virtual machine environment. In a particular embodiment, a data control system comprising a processing system is provided. The processing system is configured to provide a file system interface to a virtual machine environment and receive a file system request for the first file system represented in a first format. The processing system is further configured to convert the file system request into an application program interface (API) for the virtual machine environment.

In some embodiments, the file system request comprises a request to import data into the virtual machine environment.

In some embodiments, the processing system is configured to transfer the data into the virtual machine environment using the API.

In some embodiments, the processing system is configured to update the file system interface to reflect the transference of the data into the virtual machine environment.

In some embodiments, the first format comprises a file system write request.

In some embodiments, the file system is the New Technology File System (NTFS).

In some embodiments, the virtual machine environment further comprises one or more hypervisors that manage a plurality of data volumes.

In some embodiments, the request indicates a hypervisor of the one or more hypervisors to which data should be transferred.

In another embodiment, a computer readable medium having instructions stored thereon for operating a data control system is provided. The instructions, when executed by the data control system, direct the data control system to perform a method of file system access to a virtual machine environment. The method includes providing a file system interface to a virtual machine environment and receiving a file system request for the first file system represented in a first format. The method further includes converting the file system request into an application program interface (API) for the virtual machine environment.

### BRIEF DESCRIPTION OF THE DRAWINGS

FIG. 1 illustrates a data control system in a data control environment.

FIG. 2 illustrates operation of a data control system in a data control environment.

FIG. 3 illustrates a data control system in a data control environment.

FIG. 4 illustrates a data control system in a virtual system environment.

FIG. 5 illustrates a data control system.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Typically, in virtual machine environments, an individual agent is required for access to each virtual machine within the environment. The agent may, for example, provide a data utility with access to the contents of the virtual machine. Unfortunately, the agents typically comprise proprietary software modules. As such, data control system provides a single point of access into a virtual system environment (which may include virtual machines from various venders) through a file system interface. Providing the file system interface (or view) is discussed in co-pending U.S. Patent Application Publication No. 2011/0029972-A1 which is hereby incorporated in its entirety by reference.

The file system interface allows for a reduction in the number of agents and the ability to use off-the-shelf data utility software tools without modification. Advantageously, the file system interface also allows importation of data volumes and/or underlying data items into a virtual machine environment.

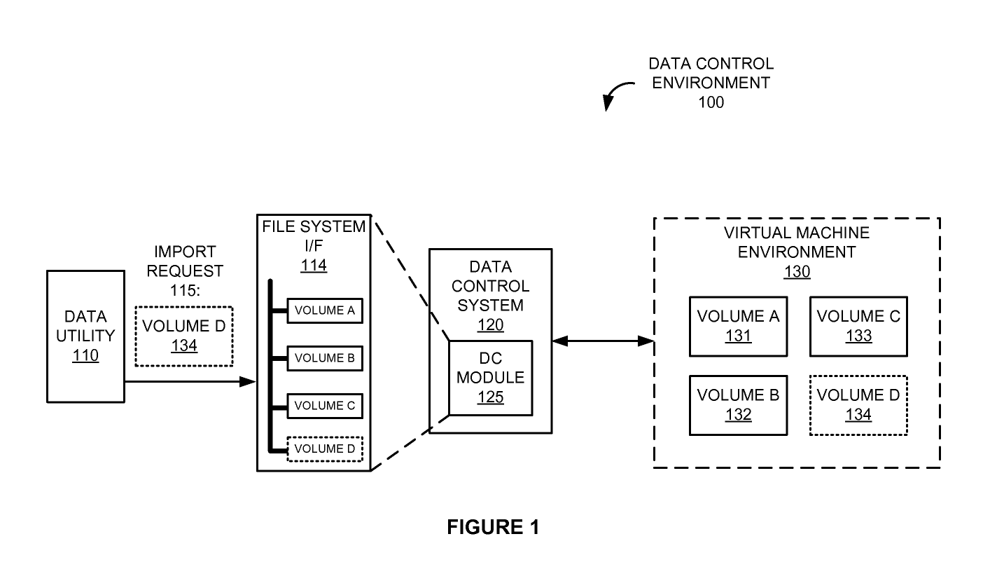

FIG. 1 illustrates a data control system in data control environment 100. Data control environment 100 includes data utility 110, import request 115, file system interface (I/F) 114, data control system 120, and virtual machine environment 130. Data control system 120 includes DC module 125. Virtual machine environment 130 includes data volume A 131, data volume B 132, and data volume C 133.

Data utility 110 comprises one or more proprietary software tools, applications, or appliances. For example, data utility 1109 may be compliance software, security software, backup software, log analytics software, replication software, and/or patch management software.

Data control system 120 comprises any system or collection of systems capable of executing DC module 125 to direct data control system to operate as described herein. Data control system 110 may be a micro-processor, an application specific integrated circuit, a general purpose computer, a server computer, or any combination or variation thereof. DC module 125 may be program instructions executable by processing system. Virtual machine environment 130 comprises any system or collection of systems that includes one or more storage volumes.

In operation, data control system 120, executing DC module 125, provides file system interface 114 of virtual machine environment 130 to data utility 110. As shown, virtual machine environment 130 initially includes data volume A 131, data volume B 132, and data volume C 133. Data utility 110 subsequently transfers import request 115 identifying target volume D 134 into virtual machine environment 130.

Data control system 120 receives import request 115 and responsively transfers data volume D 134 to virtual machine environment 130. Data control system 120 then updates the file system interface to reflect the addition of data volume D 134.

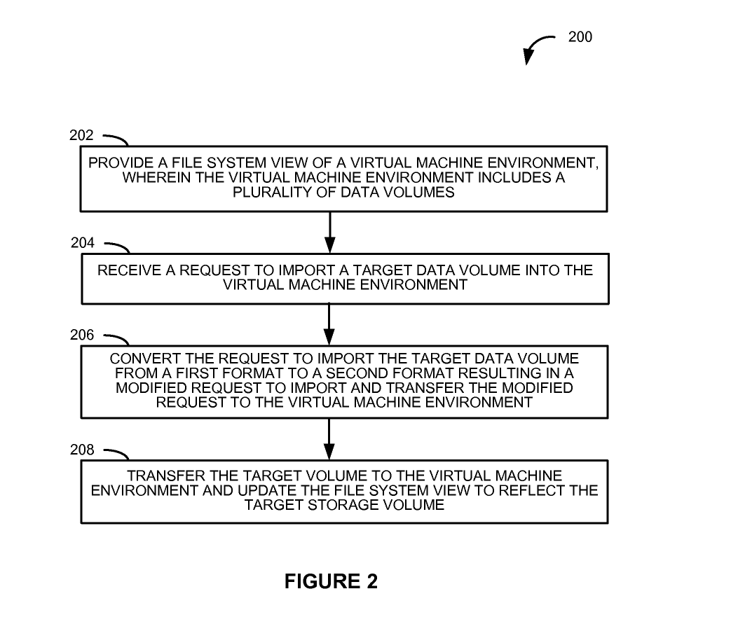

FIG. 2 illustrates process 200 describing operation of data control system 120 in virtual machine environment 130. To begin, data control system 120 executing DC module 125 provides a file system interface of a virtual machine environment wherein the virtual machine environment includes a plurality of data volumes (Step 202). For example, data control system 120 may first present file system interface 114 to data utility 110 over a network (LAN or WAN) as a shared disk. As shown in this example, file system interface 114 initially includes a data volume A, data volume B, and data volume C 133 (i.e., the initial contents of virtual storage environment 130).

In some cases, data utility 110 may see “P:\” (or a P-DRIVE). In this example, data utility 110 can then request to mount or map the P-DRIVE. In response to receiving the request to mount, data control system 120 identifies processing elements, virtual processing elements, virtual storage elements, and/or contents of virtual storage elements and generates a file system interface or view comprising the identified elements arranged in a hierarchical order. In this way, data control system 120 emulates a physical drive by allowing the data utility to mount or map a drive to view the elements and/or contents of virtual machine environment 130. Once mounted or mapped, data control system 120 provides file system interface 114 to data utility 110. Data utility 110 may then import target contents into the existing contents of virtual system environment 130 and access the existing contents of virtual system environment 130. File system interface 114 may be represented in a standard format such as, for example, FAT or NTFS, allowing data utility 110 to issue standard instructions (e.g., read/write).

Data control system 120 subsequently receives a request to import a target data volume into the virtual machine environment (Step 204). For example, data control system 120 may receive import request 115 which identifies target data volume D 134 to be imported. Data control system 120 converts the request to import the target data volume from a first format to a second format resulting in a modified request to import and transfers the modified request to import to the virtual machine environment (Step 206). For example, import request 115 may be a standard NTFS write request that is converted into a virtual machine software providers application program interface (API).

Lastly, data control system 120 transfers the target volume to the virtual machine environment and updates the file system view to reflect the addition of the target storage volume (Step 208). For example, data control system 120 may transfer target data volume D 134 to virtual machine environment 130 and update file system interface 114 to reflect the addition of data volume D 134.

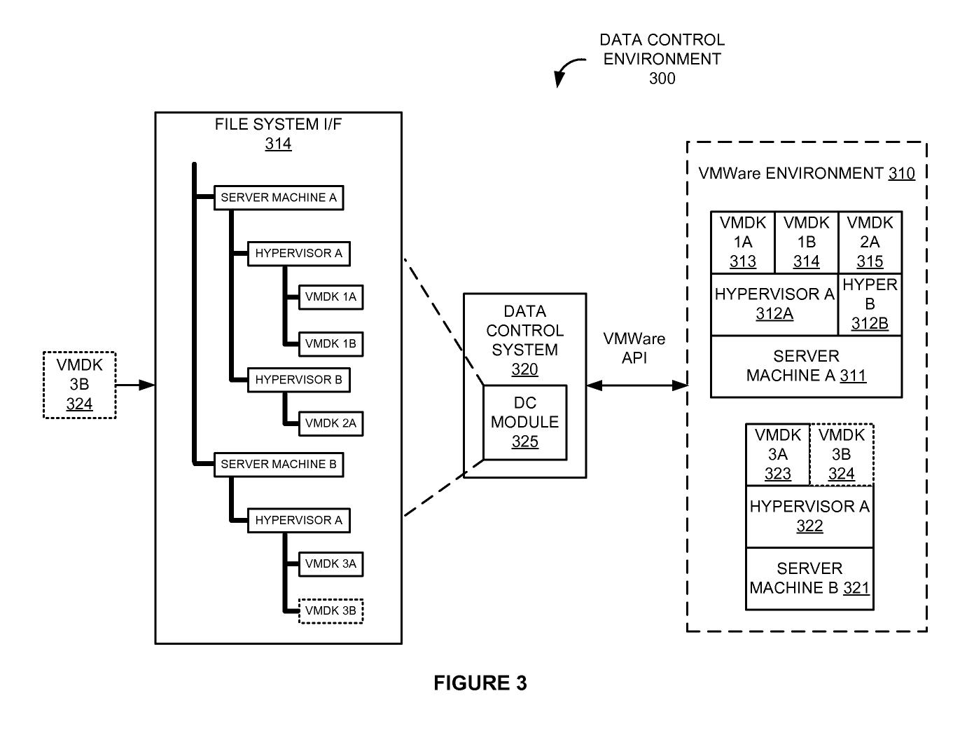

FIG. 3 illustrates a data control system in data control environment 300 for importing target elements into VMWare environment 310. Data control environment 300 includes file system interface 314, data control system 320, and VMware environment 310. Data control system 320 is in communication with virtual system environment 310.

Data control system 320 comprises any system or collection of systems capable of executing a DC module 325 to direct data control system 320 to operate as described herein. Data control system 320 may be a micro-processor, an application specific integrated circuit, a general purpose computer, a server computer, or any combination or variation thereof. DC module 325 may be program instructions executable by a processing system on data control system 320. In this example, data control system 320 is shown outside VMware environment 310; however, those skilled in the art will appreciate that in some embodiments, data control system 320 may be located within VMware environment 310.

VMware environment 310 server (or real) machines 311 and 321. Server machine 311 may be may be any computer system, custom hardware, or other device. Server machines 311 and 321 include a storage system for storing software, and may retrieve and execute software from the storage system. The storage system could include a computer-readable medium such as a disk, tape, integrated circuit, server, or some other memory device, and also may be distributed among multiple memory devices. Each server machine 311 and 321 acts as a host machine. In this example, two host machines are shown for simplicity. Those skilled in the art will appreciate that any number of host machines may be included in VMware environment 310.

Server machine 311 comprises hypervisors 312A and 312B. Hypervisors allow multiple operating systems to run concurrently on server machine 311 (i.e., a host machine). In this example two hypervisors are shown on server machine 311 for simplicity. Those skilled in the art will appreciate that more or fewer hypervisors may be present on each server machine. As shown in this example, hypervisor 312A includes two virtual disk files VMDK 1A 313 and VMDK 1B 314. The virtual disk files are associated with the hypervisor. In this example, all of the hypervisors in VMWare environment 310 are VMWare hypervisors, and thus each of the virtual disk files is a VMDK file. Those skilled in the art will appreciate that a virtual system environment may include multiple hypervisors from multiple venders or a single vender other than VMWare.

Server machine 321 comprises hypervisor 322. As shown, hypervisor 322 includes VMDK A 323. Virtual machine images or virtual disk files may be, for example, VMWare images (.vmdk files), VirtualBox images (.vdi files), Virtual Hard Disk images (.vhd), and/or other image format files, including combinations thereof. The virtual disk files or VMDK files in this example, may comprises a plurality of blocks which together may comprise one or more secondary storage volumes including data items or files (not shown for simplicity).

In operation, data control system executing DC module 325 provides file system view 314 to an appliance or application (not shown). The appliance or application accesses file system view 314 in order to write or read contents. In this example, data control system 320 receives a request to import or wire VMDK 3B 324 to VMWare environment 310. More specifically, the import request indicates that VMDK 3B 324 be imported or written to hypervisor 322 on server machine 321.

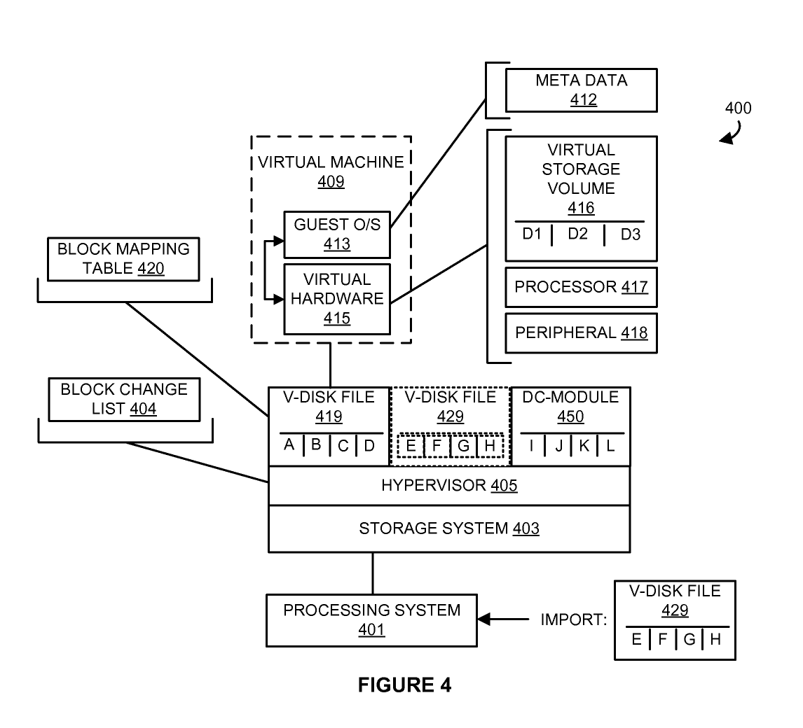

FIG. 4 illustrates an embodiment wherein the data control system is embedded in a virtual system environment 400. In this example, data control module 450 operates to provide a file system interface and transfer or import a target volume or item into virtual system environment 400. Virtual system environment 400 includes processing system 401, and storage system 403. Hypervisor 405 runs on storage system 403. Virtual disk file 419 and DC module 450 run on hypervisor 405. As shown, DC module 450 runs on hypervisor 405. However, in some embodiments, DC module 450 may run directly on storage system 403, on another hypervisor (not shown) running on storage system 403, and/or on another storage system (not shown). Although not shown in this example, those skilled in the art will appreciate that in some embodiments DC module 450 may run on storage systems outside of virtual system environment 400.

Hypervisor 405 keeps track of those data blocks that have changed using a block change list 404. Block change list 404 describes the blocks that have changed in virtual disk file 519. In some example, hypervisor 405 generates block change list 404. Those skilled in the art will appreciate that block change list 404 may alternatively or additionally be generated by any entity within virtual machine 409 (such as guest operating system 413), processing system 401, and/or storage system 403. Moreover, changed block list 404 may be generated by replication software, continuous data protection (CDP) software, or virtual disk change block tracking software running on virtual machine 409, hypervisor 405, or processing system 401.

Virtual disk file 419 may be, for example, VMWare images (.vmdk files), VirtualBox images (.vdi files), Virtual Hard Disk images (.vhd), and/or other image format files, including combinations thereof. Virtual disk file 419 includes block mapping tables. Block mapping table 420 describes the storage of the data volume in virtual disk file 519. For example, block mapping table 520 may describe the correspondence between data items (D1, D2, and D3) on virtual storage volume 416 and underlying virtual disk file 419.

As discussed, hypervisor 405 includes virtual machines represented by v-disk file 419. In particular, v-disk file 419 represents virtual machine 409. Virtual machine 409 includes guest operating system 413 and virtual hardware 415. Guest operating system 413 includes meta data 412. Virtual hardware 415 includes virtual storage volume 416, virtual processor 417, and virtual peripheral 418.

In operation, processing system 401, executing software including DC module 450, provides a file system view of the contents of virtual system environment 400, and receives a request to transfer or write v-disk file 429 (including a virtual machine which is not shown for simplicity) into virtual machine environment 400 on hypervisor 405. DC module 450 responsively transfers the virtual machine into the system converting the write instruction from a first standard format to an API supported by the hypervisor. Advantageously, a data utility or other application can transfer a virtual machine image file (i.e., v-disk file 429) from, for example, a USB thumb drive or other data utility.

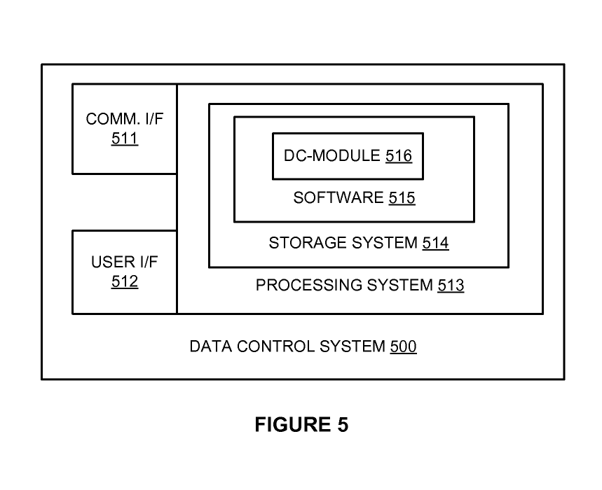

FIG. 5 illustrates data control system 500. Data control system 500 provides an example of data control system 120 of FIG. 1, data control system 320 of FIG. 3, and embedded DC module of FIG. 4, although this system may use alternative configurations. Data control system 500 includes processing system 513, user interface 512, and communication interface 511. User interface 512 may be excluded in some embodiments. Processing system 513 includes storage system 514. Storage system 514 stores software 515. Processing system 513 is linked to user interface 512 and communication interface 511. Software 515 includes DC-module 516. DC-module 516 provides an example of DC module 115 of FIG. 1, DC module 315 of FIG. 3, and DC module 450 of FIG. 4, although these systems may use alternative configurations.

Data control system 500 could be comprised of a programmed general-purpose computer, although those skilled in the art will appreciate that programmable or special purpose circuitry and equipment may be used. Data control system 500 may be distributed among multiple devices that together comprise elements 511-515.

Communication interface 511 is configured to communicate with a virtual machine environments including virtual machine environment 120 of FIG. 1 and virtual machine environment 310 of FIG. 3. Additionally, communication interface 511 may be configured to communicate with one or more data utilities or other applications which may, for example, mount or map data control system 500 to access contents of a virtual environment and import contents into a virtual environment.

Communication interface 511 could comprise a network interface, modem, port, transceiver, or some other communication device. Communication interface 511 may be distributed among multiple communication devices. Processing system 513 could comprise a computer microprocessor, logic circuit, or some other processing device. Processing system 513 may be distributed among multiple processing devices.

User interface 512 could comprise a keyboard, mouse, voice recognition interface, microphone and speakers, graphical display, touch screen, or some other type of user device. User interface 512 is configured to communicate with a system operator. As discussed, user interface 512 may be omitted in some embodiments.

Storage system 514 could comprise a disk, tape, integrated circuit, server, or some other memory device. Storage system 514 may be distributed among multiple memory devices. Storage system 514 includes software 515. Software 515 may include an operating system, logs, utilities, drivers, networking software, and other software typically loaded onto a computer system. Software 515 could contain an application program, firmware, or some other form of computer-readable processing instructions. Software 515 also includes DC module 516. When executed by processing system 513, DC module 516 directs control system 500 to operate as described herein.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A data control system, comprising:
a processing system configured to:
provide a file system interface to a virtual machine environment;
receive a file system request for the first file system represented in a first format; and
convert the file system request into an application program interface (API) for the virtual machine environment.

2. The data control system of claim 1, wherein the file system request comprises a request to import data into the virtual machine environment.

3. The data control system of claim 2, further comprising:
the processing system configured to transfer the data into the virtual machine environment using the API.

4. The data control system of claim 3, further comprising:
the processing system configured to update the file system interface to reflect the transference of the data into the virtual machine environment.

5. The data control system of claim 1, wherein the first format comprises a file system write request.

6. The data control system of claim 5, wherein the file system is the New Technology File System (NTFS).

7. The data control system of claim 1, wherein the virtual machine environment further comprises one or more hypervisors that manage a plurality of data volumes.

8. The data control system of claim 7, wherein the request indicates a hypervisor of the one or more hypervisors to which data should be transferred.

9. A computer readable medium having instructions stored thereon for operating a data control system, wherein the instructions, when executed by the data control system, direct the data control system to perform a method of file system access to a virtual machine environment, the method comprising:
providing a file system interface to a virtual machine environment;
receiving a file system request for the first file system represented in a first format; and
converting the file system request into an application program interface (API) for the virtual machine environment.

10. The computer readable medium of claim 9, wherein the file system request comprises a request to import data into the virtual machine environment.

11. The computer readable medium of claim 9, further comprising:
transferring the data into the virtual machine environment using the API.

12. The computer readable medium of claim 11, further comprising:
updating the file system interface to reflect the transference of the data into the virtual machine environment.

13. The computer readable medium of claim 9, wherein the first format comprises a file system write request.

14. The computer readable medium of claim 13, wherein the file system is the New Technology File System (NTFS).

15. The computer readable medium of claim 9, wherein the virtual machine environment further comprises one or more hypervisors that manage the plurality of data volumes.

16. The computer readable medium of claim 15, wherein the request indicates a hypervisor of the one or more hypervisors to which the data should be transferred.
